(19) United States
(12) Patent Application Publication
(10) Pub. No.: US 2025/0309730 A1
(43) Pub. Date: Oct. 2, 2025

(54) OIL PUMP FLOW PASSAGE

(71) Applicant: Schaeffler Technologies AG & Co. KG, Herzogenaurach (DE)

(72) Inventors: Noah Kee, Rittman, OH (US); Michael Condo, Clinton, OH (US)

(73) Assignee: Schaeffler Technologies AG & Co. KG, Herzogenaurach (DE)

(21) Appl. No.: 18/761,794

(22) Filed: Jul. 2, 2024

Related U.S. Application Data
(60) Provisional application No. 63/572,511, filed on Apr. 1, 2024.

(51) Int. Cl. H02K 9/193; H02K 9/197

(52) U.S. Cl. CPC H02K 9/193; H02K 9/197

(57) ABSTRACT

An electric motor having a housing, a stator supported by the housing, a rotating assembly including a rotor supported for rotation relative to the stator, and an oil pump. The oil pump includes an oil pump housing having an oil passageway for the flow of oil from the housing to the rotating assembly.

### CROSS-REFERENCE TO RELATED APPLICATIONS

This application claims the benefit of U.S. Provisional Application Ser. No. 63/572,511 filed on Apr. 1, 2024, which is incorporated by reference herein in its entirety.

### TECHNICAL FIELD

The present disclosure relates generally to electric motors.

### BACKGROUND

Electric motors used in drive assemblies, such as for electric or hybrid vehicle drives, must be cooled. This can be done by flooding the cooling areas of the motor with oil from the drive system. This can be done actively using pumps. Typical electric motors pass oil from a housing directly into the rotating assembly (e.g., rotor and rotor shaft) via an opening in the center of the rotor shaft or via one or more passageways formed in the housing. Once the oil reaches the rotating assembly, the oil is dispersed and circulated to remove heat from the drive system.

### SUMMARY

Embodiments according to this disclosure provide enhanced cooling for motors where rotating components otherwise may interfere with the flow of oil to the rotating assembly. For example, some motor designs include an obstruction (e.g., a bearing carrier) that prevents delivery of oil to the rotating assembly without passing through a rotating component. Aspects of the present disclosure provide an axially extending passageway in a housing of an oil pump for delivering oil to the rotating assembly.

In accordance with one aspect, an electric motor comprises a housing, a stator supported by the housing, a rotating assembly including a rotor supported for rotation relative to the stator, and an oil pump. The oil pump includes an oil pump housing having an oil passageway for the flow of oil to the rotating assembly.

The rotating assembly and the oil pump can be coaxial. The oil passageway can extend from an axial end face of the oil pump housing. The oil passageway can extend along the axial length of the oil pump housing. The oil passageway can be in fluid communication with a shaft having a central passageway. The shaft can be an input shaft of the oil pump. The oil passageway can include a bore machined in the oil pump housing. The electric motor can include a bearing carrier coaxial with the oil pump. At least a portion of the bearing carrier can extend circumferentially about the oil pump. The bearing carrier can obstruct a flow of oil from the housing to a center of the rotating assembly, and the oil passageway can fluidly couple the housing to the center of the rotating assembly. The oil pump can include a gerotor pump driven by the rotor.

In accordance with another aspect, an oil pump comprises an oil pump housing supporting rotating pump components, the oil pump housing having an oil passageway for the flow of oil from a first axial end of the oil pump housing to a second axial end of the oil pump housing.

The oil passageway can extend from an axial end face of the oil pump housing. The oil passageway can extends along the axial length of the oil pump housing. The oil passageway can be in fluid communication with a shaft having a central passageway. The shaft can be an input shaft of the oil pump. The oil passageway can include a bore machined in the oil pump housing.

Additional embodiments are disclosed herein.

### BRIEF DESCRIPTION OF THE DRAWINGS

The foregoing Summary and the following Detailed Description will be better understood when read in conjunction with the appended drawings, which illustrate a preferred embodiment of the disclosure. In the drawings:

FIG. 1 is a cross-sectional view of a prior art electric motor.

FIG. 2 is a cross-sectional view of an electric motor having a bearing carrier.

FIG. 3 is a cross-sectional view of an electric motor having a bearing carrier and an exemplary oil pump in accordance with the present disclosure.

FIG. 4 is a cross-sectional view of an exemplary oil pump in accordance with the present disclosure.

### DETAILED DESCRIPTION

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

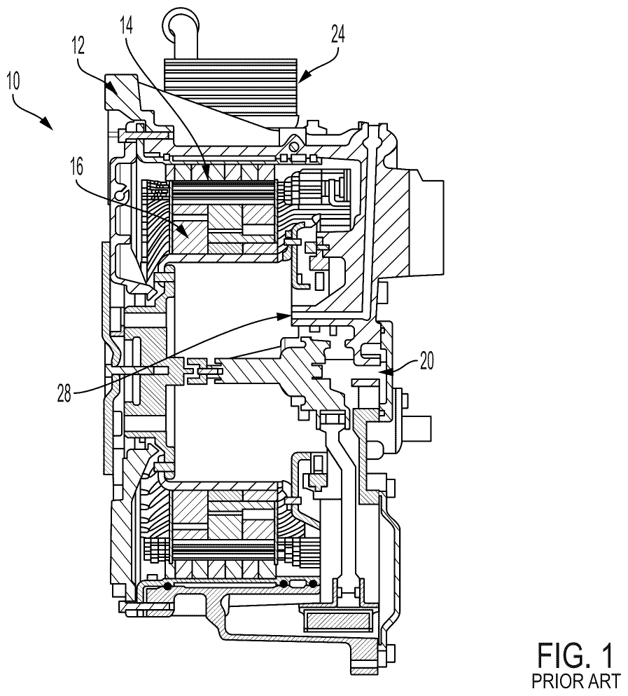

FIG. 1 illustrates a conventional electric motor 10 including a housing 12, a stator 14 and a rotor 16. An oil pump 20 circulates oil between the housing 12 and a heat exchanger 24 for cooling the electric motor 10. An oil passageway 28 is provided in the housing 12 for circulating oil to a center of the rotating assembly (e.g., rotor 16).

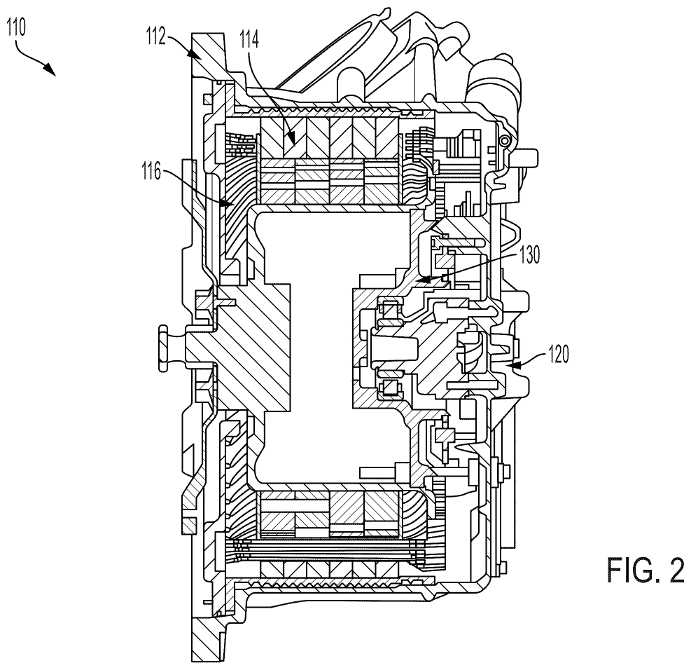

Referring to FIG. 2, another electric motor 110 is illustrated including a housing 112, a stator 114 and a rotor 116. An oil pump 120 circulates oil between the housing 112 and a heat exchanger (not shown) for cooling the electric motor 110. In this electric motor design, a bearing carrier 130 obstructs oil from flowing freely into the center of the rotating assembly without passing through rotating components which tend to prematurely disperse the oil thereby reducing the amount of oil circulated to the center of the rotating assembly.

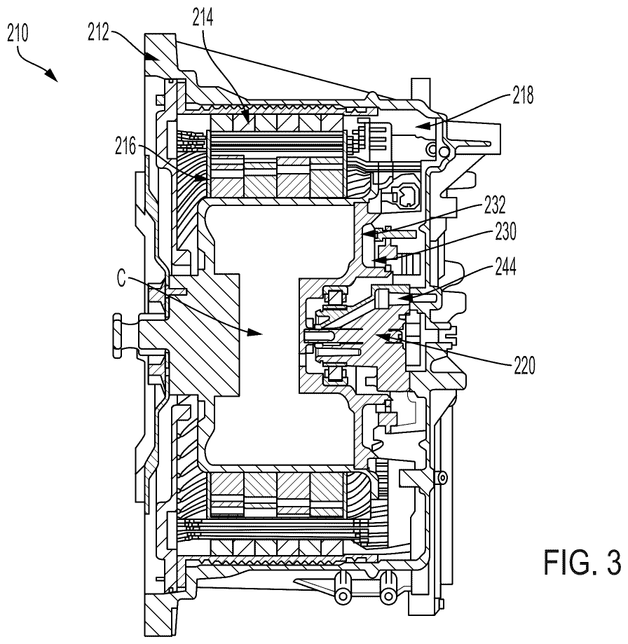

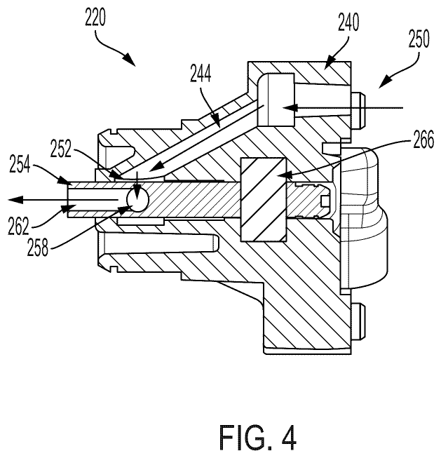

Turning to FIGS. 3 and 4, an electric motor 210 is illustrated including a housing 212, a stator 214 and a rotor 216 supported in an interior 218 of the housing 212. An oil pump 220 circulates oil between the housing 212 and a heat exchanger (not shown) for cooling the electric motor 210. Like motor 110, a bearing carrier 230 obstructs oil from flowing freely into the center C of the rotating assembly without passing through rotating components which tend to prematurely disperse the oil thereby reducing the amount of oil circulated to the center of the rotating assembly. The bearing carrier 230 and oil pump 220 are coaxial, and the bearing carrier 230 includes a flange 232 extending radially outwardly beyond the circumference of the oil pump 220.

The oil pump 220 includes an oil pump housing 240 having a flow passageway 244 for circulating oil to the center of the rotating assembly. The flow passageway 244 extends axially from a first axial end 250 of the pump 220 through the housing 240 to a chamber 252. The flow passageway 244 can include one or more bores milled or otherwise formed in the oil pump housing 240. A shaft 254 of the pump 220 includes a port 258 and central passageway 262 through which oil is directed to the rotating assembly of the electric motor 210. The shaft 254 can be driven by the rotor 216 to turn rotating pump components 266 supported in the oil pump housing 240. In some embodiments, the flow passageway 244 permits the flow of fluid from the housing 212 to the center C of the rotating assembly.

In some embodiments, the oil passageway 244 is not directly connected to a discharge of the oil pump. That is, the oil passageway 244 can be configured to receive passive flow of oil from the housing interior to the center of the rotating assembly bypassing the bearing carrier 230. The oil passageway 244 fluidly connects the interior of the housing 212 to the center of the rotating assembly C.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

### LOG OF REFERENCE NUMERALS

10 electric motor
12 housing
14 stator
16 rotor
20 oil pump
24 heat exchanger
28 oil passageway
110 electric motor
112 housing
114 stator
116 rotor
120 oil pump
130 bearing carrier
210 electric motor
212 housing
214 stator
216 rotor
218 interior of housing
220 oil pump
230 bearing carrier
232 flange
240 oil pump housing
244 oil passageway
250 first axial end of pump
252 chamber
254 shaft
258 port
262 central passageway
266 rotating pump components
C center of rotating assembly

What is claimed is:

1. An electric motor comprising:
a housing;
a stator supported by the housing;
a rotating assembly including a rotor supported for rotation relative to the stator; and
an oil pump;
wherein the oil pump includes an oil pump housing having an oil passageway for a flow of oil to the rotating assembly.

2. The electric motor according to claim 1, wherein the rotating assembly and the oil pump are coaxial.

3. The electric motor according to claim 2, wherein the oil passageway extends from an axial end face of the oil pump housing.

4. The electric motor according to claim 1, wherein the oil passageway extends along an axial length of the oil pump housing.

5. The electric motor according to claim 1, wherein the oil passageway is in fluid communication with a shaft having a central passageway.

6. The electric motor according to claim 5, wherein the shaft is an input shaft of the oil pump.

7. The electric motor according to claim 1, wherein the oil passageway comprises a bore machined in the oil pump housing.

8. The electric motor according to claim 1, wherein further comprising a bearing carrier coaxial with the oil pump.

9. The electric motor according to claim 8, wherein at least a portion of the bearing carrier extends circumferentially about the oil pump.

10. The electric motor according to claim 9, wherein the bearing carrier obstructs a flow of oil from the housing to a center of the rotating assembly, and wherein the oil passageway fluidly couples the housing to the center of the rotating assembly.

11. The electric motor according to claim 1, wherein the oil pump includes a gerotor pump driven by the rotor.

12. An oil pump for an electric motor comprising an oil pump housing supporting rotating pump components, the oil pump housing having an oil passageway for a flow of oil from a first axial end of the oil pump housing to a second axial end of the oil pump housing.

13. The oil pump according to claim 12, wherein the oil passageway extends from an axial end face of the oil pump housing.

14. The oil pump according to claim 12, wherein the oil passageway extends along an axial length of the oil pump housing.

15. The oil pump according to claim 12, wherein the oil passageway is in fluid communication with a shaft having a central passageway.

16. The oil pump according to claim 15, wherein the shaft is an input shaft of the oil pump.

17. The oil pump according to claim 12, wherein the oil passageway comprises a bore machined in the oil pump housing.
